(19) United States
(12) Patent Application Publication
(10) Pub. No.: US 2005/0050987 A1
(43) Pub. Date: Mar. 10, 2005

(54) Crank apparatus for manually powered cycles

(76) Inventor: Greg Brandt, Langley (CA)

Correspondence Address: Raymond M. Galasso;Simon, Galasso & Frantz PLC, P.O. Box 26503, Austin, TX, 78755-0503, US

(21) Appl. No.: 10/936,941

(22) Filed: Sep. 9, 2004

Related U.S. Application Data
(60) Provisional application No. 60/501,270, filed on Sep. 9, 2003.

(51) Int. Cl. G05G 1/14

(52) U.S. Cl. 74/594.3

(57) ABSTRACT

A crank apparatus for a manually powered cycle comprises a crank assembly and a pair of guide devices. The crank assembly includes a shaft, a first crank lever attached to a first end of the shaft and a second crank lever attached to a second end of the shaft. Each crank lever includes a fixed crank lever member attached to the shaft, a movable crank lever member movably attached to the fixed crank lever member and a follower device attached to the movable crank lever member. The pair of guide devices each includes a guide feature defining a non-concentric guide path with respect to a rotational axis of the shaft. The follower device of each one of the crank levers is engaged with the guide feature of a respective one of the guide devices whereby the movable crank lever member of each one of the crank levers moves between a respective retracted position and a respective extended position with respect to the fixed crank lever member when the crank assembly is rotated about the rotational axis of the shaft.

### CROSS REFERENCE TO RELATED APPLICATIONS

This application claims priority to co-pending United States Provisional Patent Application having Ser. No. 60/501,270 filed Sep. 9, 2003, entitled “Brandt Crank” and having a common applicant herewith.

### FIELD OF THE DISCLOSURE

The disclosures made herein relate generally to crank apparatuses for manually powered cycles and, more particularly, to cycle crank apparatuses offering improved power stroke capability.

### BACKGROUND

Various types of crank apparatuses for bicycles (i.e., a manually-powered cycle) are known and widely used. Such apparatuses are hereinafter referred to generally as conventional crank apparatuses. In the most basic configuration, conventional crank apparatuses include a shaft, one or more drive sprockets, crank levers and pedals. Each one of the crank levers is attached at a first end to a respective end of the shaft. The crank levers are typically 180 offset from each other. A pedal is attached to the second end of each one of the crank levers. The one or more drive sprockets are attached to one of the crank levers, the shaft or both.

The rider of a cycle applies force to the pedals, thereby generating a corresponding amount of rotational power. For a given applied force from the rider, the distance between the rotational axis of each pedal and the shaft determines the amount of torque applied to the driveline of a cycle. Accordingly, from torque and power standpoints, longer crank lever length is typically desirable over a shorter one.

Factors in determining the length of the crank levers include ground clearance and leg length of typical riders. Obviously, the length of the crank levers must provide suitable ground clearance during typical riding situations and properly fit the leg length of typical riders. As seat height is typically adjustable on most cycles, ground clearance is generally the primary factor in determining crank lever length.

Therefore, a crank apparatus that provides for increased torque application through a relative long crank lever length and that overcomes length-related drawbacks associated with conventional crank apparatuses would be useful, advantageous and novel.

### SUMMARY OF THE DISCLOSURE

In one embodiment, a crank apparatus for a manually powered cycle comprises a crank assembly and a guide device. The crank assembly includes a shaft, a fixed crank lever member attached to the shaft, a movable crank lever member movably attached to the fixed crank lever member and a follower device attached to the movable crank lever member. The guide device includes a guide feature defining a non-concentric guide path with respect to a rotational axis of the shaft. The follower device follows the guide feature whereby the movable crank lever member moves between a retracted position and an extended position with respect to the fixed crank lever member when the crank assembly is rotated about the rotational axis of the shaft.

In another embodiment, a manually powered cycle comprises a frame, a crank assembly and a guide device. The frame includes a crank assembly hub. The crank assembly includes a shaft rotatably mounted on the crank assembly hub, a fixed crank lever member attached to the shaft, a movable crank lever member movably attached to the fixed crank lever member and a follower device attached to the movable crank lever member. The guide device is attached to the frame and includes a guide feature defining a non-concentric guide path with respect to a rotational axis of the shaft. The follower device is engaged with the guide feature whereby the movable crank lever member moves between a retracted position and an extended position with respect to the fixed crank lever member when the crank assembly is rotated about the rotational axis of the shaft.

In another embodiment, a crank apparatus for a manually powered cycle comprises a crank assembly and a pair of spaced apart guide devices. The crank assembly includes a shaft, a first crank lever attached to a first end of the shaft and a second crank lever attached to a second end of the shaft. Each crank lever includes a fixed crank lever member attached to the shaft, a movable crank lever member movably attached to the fixed crank lever member and a follower device attached to the movable crank lever member. The pair of guide devices each includes a guide feature defining a non-concentric guide path with respect to a rotational axis of the shaft. The follower device of each one of the crank levers is engaged with the guide feature of a respective one of the guide devices whereby the movable crank lever member of each one of the crank levers moves between a respective retracted position and a respective extended position with respect to the fixed crank lever member when the crank assembly is rotated about the rotational axis of the shaft.

Correspondingly, it is a principal object of the inventive disclosures made herein to provide a crank apparatus that provides for increased torque application through a relative long crank lever length and that overcomes crank lever length related drawbacks associated with conventional crank apparatuses. Specifically, crank lever length is variable dependent upon angular crank position. Accordingly, embodiments of crank apparatuses in accordance with the inventive disclosures made herein provide improved power stroke capability through variable and, optionally, adjustable crank lever length.

Turning now to specific embodiments of the inventive disclosures made herein, in at least one embodiment of the inventive disclosures made herein, a guide feature is one of substantially non-circular and substantially circular.

In at least one embodiment of the inventive disclosures made herein, the center point of a substantially circular guide feature is offset from a rotational axis of the shaft.

In at least one embodiment of the inventive disclosures made herein, the guide device is selectively movable between a first orientation and a second orientation with respect to the rotational axis of the shaft.

In at least one embodiment of the inventive disclosures made herein, the guide feature includes offset races, a guide channel is defined between the races and the follower device is positioned within the guide channel.

In at least one embodiment of the inventive disclosures made herein, the shaft includes a fluid communication passage extending between first and second ends thereof, the fixed crank lever member is attached to the first end of the shaft, the fixed crank lever member and the movable crank lever member jointly define a variable-volume fluid chamber, the fixed crank lever member includes a fluid communication passage extending between the variable-volume fluid chamber and the first end of the shaft, and movement of the movable crank lever member between the extended position and the retracted position results in a corresponding change in the variable volume fluid chamber.

In at least one embodiment of the inventive disclosures made herein, the crank assembly includes means for biasing the movable crank lever member to the retracted position.

These and other objects and embodiments of the inventive disclosures made herein will become readily apparent upon further review of the following specification and associated drawings.

### BRIEF DESCRIPTION OF THE DRAWINGS

FIG. 1 depicts an embodiment of a bicycle in accordance with the inventive disclosures made herein.

FIG. 2 depicts an embodiment of the variable-length crank apparatus of the bicycle depicted in FIG. 1

FIG. 3 depicts an embodiment of a fluid assisted crank apparatus in accordance with the inventive disclosures made herein.

FIG. 4 depicts an embodiment of a crank lever having external anti-rotation means incorporated therein in accordance with the inventive disclosures made herein.

### DETAILED DESCRIPTION OF THE DRAWINGS

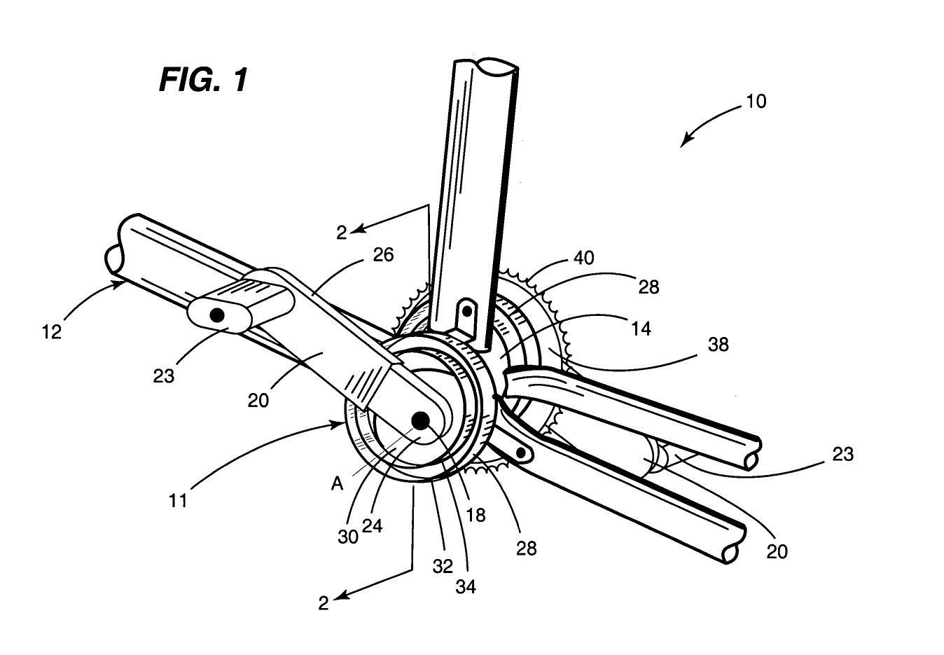

FIG. 1 depicts an embodiment of a bicycle 10 and crank assembly 11 in accordance with the inventive disclosures made herein. The bicycle 10 includes a frame 12 configured for having conventional components mounted thereon (e.g., wheels, seat, handle bars, etc). The frame 12 is also configured for having a crank apparatus in accordance with the inventive disclosures made herein mounted thereon.

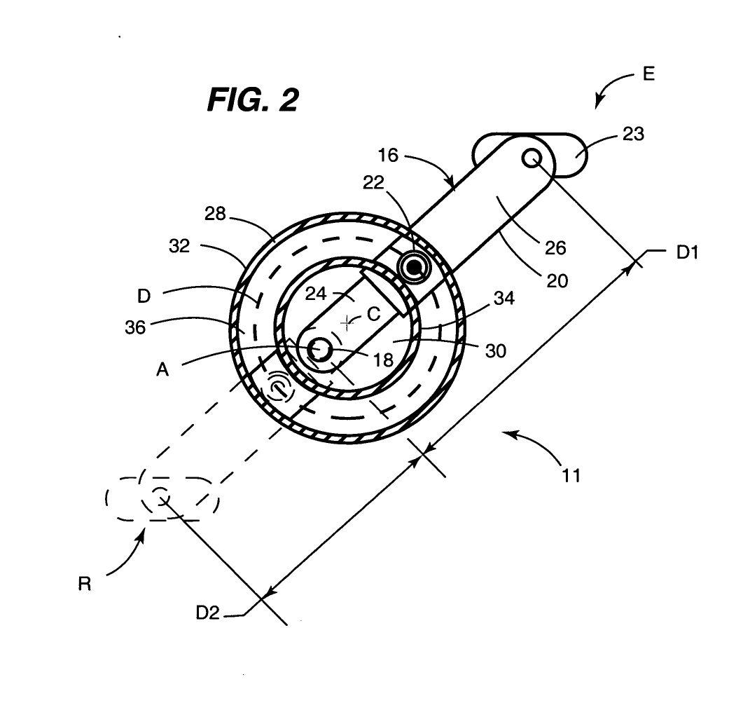

Referring now to FIGS. 1 and 2, the frame 12 includes a crank assembly hub 14 having the crank assembly 11 mounted thereon. The crank assembly 11 includes a shaft 18, crank levers 20, follower devices 22 (only one shown) and pedals 23. The shaft 18 is preferably mounted on spaced apart bearings (not specifically shown in FIGS. 1 and 2) that are fitted within a bore of the crank assembly hub 14. Accordingly, the shaft 18 is rotatably mounted on the frame 12. Each crank lever 20 is fixedly attached at a first end to a respective end of the shaft 18 and has one of the pedals 23 attached at a second end. As is conventionally the case, the crank levers 20 are rotationally offset by about 180 degrees.

Each crank lever 20 includes a fixed crank lever member 24 and a movable crank lever member 26. The fixed crank lever member 24 is fixedly attached to the shaft 18 and the movable crank lever member 26 is movably attached to the fixed crank lever member 24. The follower device 22 is attached to the movable crank lever member 26. The fixed crank lever member 24 and the movable crank lever member 26 are attached in a manner enabling the movable crank lever member 26 to move between an extended position E and a retracted position R with respect to the fixed crank lever member 24.

Two guide devices 28 are attached to the frame 12. Preferably, as depicted in FIG. 1, the guide devices 28 have essentially the same relative positions on opposing sides of the frame 12. A first one of the guide devices 28 is attached to the frame 12 adjacent a first end of the shaft 18 and a second one of the guide devices 28 is attached to the frame 12 adjacent the a second end of the shaft 18. Each one of the guide devices 28 includes a passage 30 and is positioned with the respective end of the shaft 18 accessible through and/or extending through the passage 30.

Each one of the guide devices 28 includes an outer race 32 and an inner race 34 (i.e., spaced apart races). The outer race 32 and the inner race 34 jointly define a guide channel 36. In other embodiments (not shown), a single race is provided and a second follower device is implemented in a manner where the race is captured between the two spaced apart follower devices and each one of the follower devices engages a respective surface (i.e., a guide feature) of the race.

As depicted in FIG. 2, the guide channel 36 (i.e., a guide feature) is substantially circular in profile. Center point C of the guide channel 36 is offset from the rotational axis A (FIG. 2) of the shaft 18. In this manner, the profile of the guide channel 36 defines a non-concentric guide path with respect to the rotational axis A of the shaft 18. As depicted in FIG. 2, the follower device 22 is positioned within the guide channel 36 whereby the movable crank lever member 26 moves between the retracted position R and the extended position E with respect to the fixed crank lever member 24 when the crank assembly 11 is rotated about the rotational axis A of the shaft 18.

Advantageously, the guide device 28 and the crank levers 20 are jointly configured for imparting the magnitude and angular position of the retracted position R and the extended position E. In this manner, the crank levers are movable through an extended length range during a first angular duration such that applied torque during the power stroke can be enhanced and are movable through a retracted length range during a second angular duration such that suitable ground clearance is provided. Such movement through the extended and retracted length ranges represent variable crank length functionality in accordance with the inventive disclosures made herein.

As depicted in FIGS. 1 and 2, center point C of the guide channels 36 is vertically and horizontally offset with respect to the rotational axis A of the shaft 18. For the specific orientation depicted in FIGS. 1 and 2 (i.e., the center point C is offset upward and forward with respect to the rotation al axis A), maximum extension of the movable crank lever 26 will occur between the 12 o'clock and 3 o'clock positions. Because the guide channel 36 has a circular profile, maximum retraction will occur between the 6 o'clock and 9 o'clock positions (i.e., 180 degrees from maximum extension).

In view of the inventive disclosures made herein, it will be appreciated that the specific magnitudes and angular locations of maximum extension and retraction can be altered by specific placement of the guide devices 28 and their relative size. For a given offset position of the guide device 28, the movable crank lever member 26 will exhibit a translated distance (i.e., D1 minus D2) for a given guide channel diameter D (i.e., the guide channel size). For example, for a 1-inch offset, a 4-inch guide channel diameter will yield a 4-inch translated distance. Similarly, for a given guide channel diameter D, the translated distance can be increased or decreased by a corresponding change in position of the guide channel 36 relative to the rotational axis A of the shaft 18. For example, for a 4-inch guide channel diameter, reducing the offset from a 1-inch offset to a 0.5-inch offset will yield a 2-inch translated distance. The angular locations of maximum extension and retraction are dictated by the angular position of the center point C of the guide device 28 relative to the rotational axis A of the shaft 18.

In the embodiment of the bicycle 10 depicted in FIG. 1, the follower device 22 on the right side of the bicycle 10 extends though a passage (not specifically shown) in a drive sprocket 38. The drive sprocket 38 is fixedly attached to the fixed crank lever 24 on the right side of the bicycle 10, to the shaft 18 or both. Chain engagement teeth 40 are provided at the periphery portion of the drive sprocket 38. Accordingly, the drive tooth diameter of the drive sprocket 38 will limit the maximum translated distance in that the follower device 22 cannot breach the periphery of the drive sprocket 38.

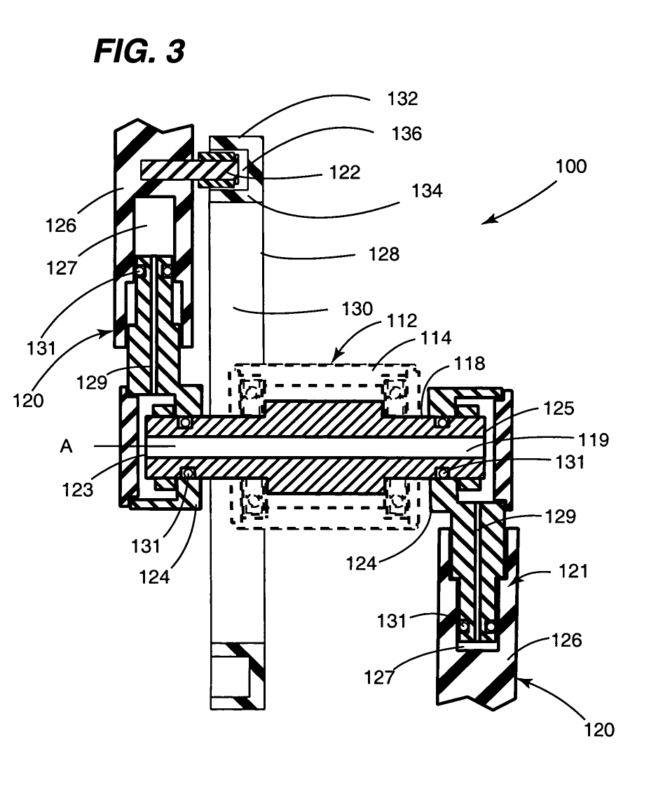

FIG. 3 depicts an embodiment of a fluid-assisted crank apparatus 100 in accordance with the inventive disclosures made herein. The fluid-assisted crank assembly 100 is configured for providing increased space on one side of the crank assembly hub (e.g., the drive sprocket side) and removing drive tooth diameter limitations, while still providing variable-length crank lever functionality in accordance with the inventive disclosures made herein. Such a configuration is particularly advantageous where a relatively small drive sprocket is present and/or where it is undesirable and/or impractical for such variable-length crank lever functionality to rely on the presence of a suitably configured passage in one or more drive sprockets.

The crank assembly 100 is rotatably mounted on a crank assembly hub 114 of a frame 112. The crank assembly 100 includes a shaft 118, a first crank lever 120, a second crank lever 121 and a follower device 122. The shaft 118 is preferably mounted on spaced apart bearings that are fitted within a bore of the crank assembly hub. Accordingly, the shaft 18 is rotatably mounted on the frame. Each one of the crank levers (120, 121) is fixedly attached at a first end to a respective end of the shaft 118 and has a pedal (not specifically shown in FIG. 3) attached to a second end. As is conventionally the case, the crank levers (120, 121) are rotationally offset by 180 degrees.

Each crank lever (120, 121) includes a fixed crank lever member 124 and a movable crank lever member 126. The fixed crank lever member 124 is fixedly attached to the shaft 118 and the movable crank lever member 126 is movably attached to the fixed crank lever member 124. The follower device 122 is attached to the movable crank lever member 126 of first crank lever 120. The fixed crank lever member 124 and the movable crank lever member 126 of each crank lever (120, 121) are attached in a manner enabling the movable crank lever member 126 to moved between an extended position E and a retracted position R with respect to the fixed crank lever member 124.

A guide device 128 is attached to the frame 112 and is positioned on the opposite side of the frame 112 from one or more drive sprockets (not shown). The guide device 128 includes a passage 130 and is positioned with the respective end of the shaft 118 extending through the passage 130. The guide device 128 includes an outer race 132 and an inner race 134 (i.e., spaced apart races). The outer race 132 and the inner race 134 jointly define a guide channel 136. To provide the same guide path for both pedals, the guide channel 136 has a symmetric, non-circular profile. Examples of such symmetric, non-circular profiles include elliptical and oval profiles.

It will be appreciated that such a non-circular profile will result preclude non-variable crank lever operation. It will also be appreciated that the specific position of the guide channel 136 with respect to the rotational axis A of the shaft 118 will have an impact on the magnitudes and angular locations of maximum extension and retraction.

As depicted in FIG. 3, the follower device 122 is positioned within the guide channel 136. Accordingly, during rotation of the crank assembly 100 about the rotational axis A of the shaft 118, the follower device 122 follows the guide path defined by the guide channel 136 thereby causing the movable crank lever member 126 of the first crank lever 120 to move between its retracted position R and the extended position E with respect to the fixed crank lever member 124.

The crank levers (120, 121) and the shaft 118 are configured in a manner where fluid communication facilitates the movable crank lever member 126 of the second crank lever 121 following the same guide path as the movable crank lever member 126 of the first crank lever 120, but 180-degrees out of phase. The shaft 118 includes a fluid communication passage 119 extending between a first end 123 and a second end 125 of the shaft 118. The fixed crank lever member 124 and the movable crank lever member 126 of each crank lever (120, 121) jointly define a respective variable-volume fluid chamber 127. The fixed crank lever member 124 of each crank lever (120, 121) includes a fluid communication passage 129 that extends between the respective variable-volume fluid chamber 127 and the respective end (123, 125) of the shaft 118.

The fluid chambers 127 and the fluid passages are filled with a fluid. During filling with fluid, the two cranks are maintained in opposite corresponding positions. For example, during filling, one of the crank levers is positioned in the fully retracted position and the other is positioned in the fully extended position.

A substantially incompressible fluid such as hydraulic oil is a preferred fluid. However, a pneumatic arrangement where air or other gas is the fluid is also contemplated. Seals 131 are provided for maintaining a closed system. In at least one embodiment of the crank levers (120, 121), means (not specifically shown), such as a spring, is provided for biasing the movable crank lever member to the respective retracted position. In cases where a substantially compressible gas (e.g., air) is the chosen fluid, the means for biasing serves to limit compressibility of the movable crank lever member relative to the fixed crank lever member. In all cases, the means for biasing limits the reliance on fluid transfer moving a movable crank lever member from the extended position to the retracted position.

Accordingly, as the follower device 122 follows the guide channel 136 during rotation of the crank assembly 100, the movable crank lever member 126 of the first crank lever 120 correspondingly moves between its extended and retracted positions. Movement of the movable crank lever member 126 of the first crank lever 120 causes a change in volume of the fluid chamber 127 of the first crank lever 120, resulting in an equal and opposite volume change in the fluid chamber 131 of the second crank lever 121 as fluid is communicated through the fluid communication passages (119, 129). In this manner, extension and contraction of the movable crank lever 126 of the first crank lever 120 controls corresponding and opposite movement of the movable crank lever member 126 of the second crank lever 121.

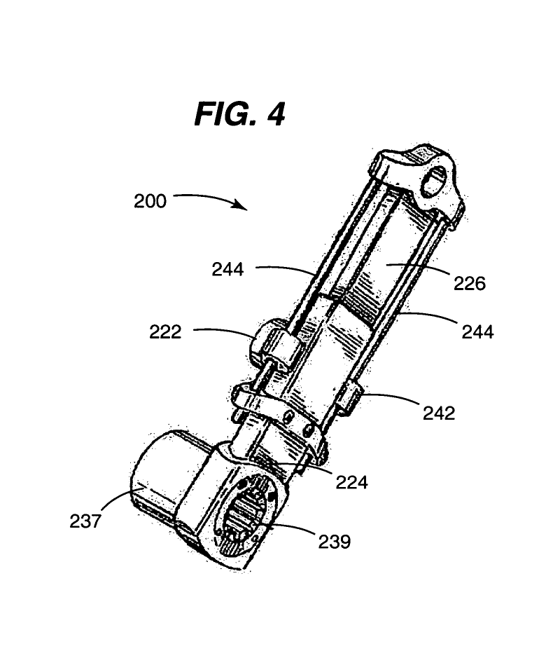

FIG. 4 depicts an embodiment of a crank lever 200 having an externally mounted stabilizing means. The crank lever 200 includes a fixed crank lever member 224 and a movable crank lever member 226. The movable crank lever member 226 is longitudinally movable with respect to the fixed crank lever member 224. The fixed crank lever member includes a shaft mount 237 that includes internal splines 239 configured for engaging mating splines of a crank assembly shaft (e.g., the shaft 118 depicted in FIG. 3. A slider 242 is attached to the movable crank lever member 226 and carries a follower device 222. In one embodiment, the crank lever 200 is configured for fluid assisted operation in accordance with the inventive disclosures made herein.

Stabilizing members 244 are attached to the fixed and movable crank lever members (225, 226), extending longitudinally along the length of the crank lever 200. The stabilizing members are slidably attached to at least the fixed or movable crank lever members (224, 226). The stabilizing members 244 serve as a means for limiting rotation of the movable crank lever member 226 with respect to the fixed crank lever member 224. The slider 242 is slidably engaged with the stabilizing members 244 thereby providing guide means.

While not specifically shown, means for enabling the guide devices to be selectively movable is contemplated and disclosed herein. Implementing a means for enabling the guide devices to be selectively movable provides for active variation in the magnitude and/or angular locations of maximum extension and retraction. One embodiment of such a means provides for discrete vertical, horizontal and angular movement. Other embodiments of such a means provides for different combinations of translational (i.e., horizontal and/or vertical) movement and rotational movement. Still other embodiments will provide for only horizontal, vertical or angular movement.

Guide devices having a guide feature (e.g., guide channel, guide surface, etc) with a non-circular shape are contemplated and disclosed herein. As will be appreciated by the skilled person, guide features having a non-circular shape will enable a desired and/or advantageous guide path to be achieved. Examples of such non-circular shapes include oval, elliptical, single-lobe and dual lobe. Additionally, ‘designer’ shapes that do not have a conventional geometric shape are examples of such non-circular shapes. In one embodiment, such ‘designer’ shapes are preferably computer-generated for achieving a desired and/or advantageous guide path (e.g., which provides a desired and/or advantageous kinematic characteristic).

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosures made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A crank apparatus for a manually powered cycle, comprising:
a crank assembly including a shaft, a fixed crank lever member attached to the shaft, a movable crank lever member movably attached to the fixed crank lever member and a follower device attached to the movable crank lever member; and
a guide device including a guide feature defining a non-concentric guide path with respect to a rotational axis of the shaft;
wherein the follower device follows the guide feature whereby the movable crank lever member moves between a retracted position and an extended position with respect to the fixed crank lever member when the crank assembly is rotated about the rotational axis of the shaft.

2. The apparatus of claim 1 wherein:
the guide feature is one of substantially non-circular and substantially circular; and
a center point of said substantially circular guide feature is offset from the rotational axis of the shaft.

3. The apparatus of claim 1 wherein the guide device is selectively movable between a first orientation and a second orientation with respect to the rotational axis of the shaft.

4. The apparatus of claim 1 wherein:
the guide feature includes offset races;
a guide channel is defined between said races; and
the follower device is positioned within the guide channel.

5. The apparatus of claim 1 wherein:
the shaft includes a fluid communication passage extending between first and second ends thereof;
the fixed crank lever member is attached to said first end of the shaft;
the fixed crank lever member and the movable crank lever member jointly define a variable-volume fluid chamber;
the fixed crank lever member includes a fluid communication passage extending between the variable-volume fluid chamber and the first end of the shaft; and
movement of the movable crank lever member between the extended position and the retracted position results in a corresponding change in the variable volume fluid chamber.

6. The apparatus of claim 5 wherein the crank assembly includes means for biasing the movable crank lever member to the retracted position.

7. The apparatus of claim 1 wherein:
the guide feature is one of substantially non-circular and substantially circular;
a center point of said substantially circular guide feature is offset from the rotational axis of the shaft;
the guide feature includes offset races;
a guide channel is defined between said races; and
the follower device is positioned within the guide channel.

8. The apparatus of claim 7 wherein:
the shaft includes a fluid communication passage extending between first and second ends thereof;
the fixed crank lever member is attached to said first end of the shaft;
the fixed crank lever member and the movable crank lever member jointly define a variable-volume fluid chamber;
the fixed crank lever member includes a fluid communication passage extending between the variable-volume fluid chamber and the first end of the shaft; and
movement of the movable crank lever member between the extended position and the retracted position results in a corresponding change in the variable volume fluid chamber.

9. A manually powered cycle, comprising:
a frame including a crank assembly hub;
a crank assembly including a shaft rotatably mounted on the crank assembly hub, a fixed crank lever member attached to the shaft, a movable crank lever member movably attached to the fixed crank lever member and a follower device attached to the movable crank lever member; and
a guide device attached to the frame and including a guide feature defining a non-concentric guide path with respect to a rotational axis of the shaft;
wherein the follower device is engaged with the guide feature whereby the movable crank lever member moves between a retracted position and an extended position with respect to the fixed crank lever member when the crank assembly is rotated about the rotational axis of the shaft.

10. The apparatus of claim 9 wherein:
the guide feature is one of substantially non-circular and substantially circular; and
a center point of said substantially circular guide feature is offset from the rotational axis of the shaft.

11. The apparatus of claim 9 wherein the guide device is selectively movable between a first orientation and a second orientation with respect to the rotational axis of the shaft.

12. The apparatus of claim 9 wherein:
the guide feature includes offset races;
a guide channel is defined between said races; and
the follower device is positioned within the guide channel.

13. The apparatus of claim 9 wherein:
the shaft includes a fluid communication passage extending between first and second ends thereof;
the fixed crank lever member is attached to said first end of the shaft;
the fixed crank lever member and the movable crank lever member jointly define a variable-volume fluid chamber;
the fixed crank lever member includes a fluid communication passage extending between the variable-volume fluid chamber and the first end of the shaft; and
movement of the movable crank lever member between the extended position and the retracted position results in a corresponding change in the variable volume fluid chamber.

14. The apparatus of claim 13 wherein the crank assembly includes means for biasing the movable crank lever member to the retracted position.

15. The apparatus of claim 9 wherein:
the guide feature is one of substantially non-circular and substantially circular;
a center point of said substantially circular guide feature is offset from the rotational axis of the shaft;
the guide feature includes offset races;
a guide channel is defined between said races; and
the follower device is positioned within the guide channel.

16. The apparatus of claim 15 wherein:
the shaft includes a fluid communication passage extending between first and second ends thereof;
the fixed crank lever member is attached to said first end of the shaft;
the fixed crank lever member and the movable crank lever member jointly define a variable-volume fluid chamber;
the fixed crank lever member includes a fluid communication passage extending between the variable-volume fluid chamber and the first end of the shaft; and
movement of the movable crank lever member between the extended position and the retracted position results in a corresponding change in the variable volume fluid chamber.

17. A crank apparatus for a manually powered cycle, comprising:
a crank assembly including a shaft, a first crank attached to a first end of the shaft and a second crank attached to a second end of the shaft, wherein each crank includes a fixed crank lever member attached to the shaft, a movable crank lever member movably attached to the fixed crank lever member and a follower device attached to the movable crank lever member; and
a pair of guide devices each including a guide feature defining a non-concentric guide path with respect to a rotational axis of the shaft;
wherein the follower device of each one of said crank levers is engaged with the guide feature of a respective one of said guide devices whereby the movable crank lever member of each one of said crank levers moves between a respective retracted position and a respective extended position with respect to the fixed crank lever member when the crank assembly is rotated about the rotational axis of the shaft.

18. The apparatus of claim 17 wherein:
the guide feature of each one of said guide devices is one of substantially non-circular and substantially circular; and
a center point of said substantially circular guide feature is offset from the rotational axis of the shaft.

19. The apparatus of claim 17 wherein:
the guide feature includes offset races;
a guide channel is defined between said races; and
the follower device is positioned within the guide channel.

20. The apparatus of claim 17 wherein:
the guide feature is one of substantially non-circular and substantially circular;
a center point of said substantially circular guide feature is offset from the rotational axis of the shaft;
the guide feature includes offset races;
a guide channel is defined between said races; and
the follower device is positioned within the guide channel.
